(19) United States
(12) Patent Application Publication
(10) Pub. No.: US 2017/0089458 A1
(43) Pub. Date: Mar. 30, 2017

(54) RETAINING DEVICE, AND PIN TO BE PLACED IN A RETAINING DEVICE OF SAID TYPE

(71) Applicant: ECS Engineered Control Systems AG, St. Gallen (CH)

(72) Inventor: Heiko SCHIRMER, Regesbostel (DE)

(73) Assignee: ECS Engineered Control Systems AG, St. Gallen (CH)

(21) Appl. No.: 15/312,356

(22) PCT Filed: May 20, 2015
(86) PCT No.: PCT/EP2015/061066

§ 371 Date: Nov. 18, 2016

(30) Foreign Application Priority Data
May 20, 2014 (DE) 10 2014 107 080.1

(51) Int. Cl. F16H 61/24; G05G 5/06; F16H 59/02

(52) U.S. Cl. CPC F16H 61/24; F16H 59/0278; G05G 5/06; F16H 2061/247; F16H 2059/0295; G05G 2505/00

(57) ABSTRACT

The invention relates to a retaining device (10) comprising a) a holder (2) that includes a receptacle (1), b) a spring-biased pin (4) which is guided so as to be longitudinally movable in the receptacle (1) of the holder (2) and which includes a pin head (3) that protrudes from the receptacle (1) of the holder (2), c) a centering mechanism (5) which is stationarily arranged on the pin (4) and is provided with a restoring force within the receptacle (1) of the holder (2), said restoring force being directed against the holder (2).

### CROSS-REFERENCE TO RELATED APPLICATIONS

This application is a national stage application (under 35 USC §371) of PCT/EP2015/061066, filed May 20, 2015, which claims benefit of German application No. 10 2014 107 080.1, filed May 20, 2014, the contents of each of which are incorporated by reference herein.

### BACKGROUND OF THE INVENTION

Technical Field and State of the Art

The invention concerns a holding device as well as a pin for arrangement in such a holding device, such as for use in a shifting device for a motor vehicle.

From DE 103 44 287 A1 there is known both such a holding device and such a pin for arrangement in such a holding device. Such holding devices and such pins are parts of a locking device, which find use in a shifting device for motor vehicles. The pin there is fashioned as a cylinder and has at its one end a pin head. By its cylindrical body, the pin is displaceably arranged in a seat of a mounting bracket and spring-loaded in the axial direction by means of a compression spring. Between this seat of the mounting bracket and the pin there is arranged a slotted ring as a centering device. Together with a pin head seat, the mounting bracket there in combination with the pin forms the mentioned locking device. The pin head lies against a contact surface of the pin head seat, and by the spring loading of the pin the pin head stands in constant contact with the contact surface of the pin head seat. At the end of the holding device opposite the pin head, the latter is arranged on a shifting device. The holding device stands in direct contact with a shift lever, which is mounted in a pivot and able to swivel about two swivel axes.

The slotted ring fashioned as a centering device bears by a slanting bearing contour against a complementary slanting bearing contour of the pin and thus holds it centered in the seat of the holding device. The slot of the ring is fashioned axially to the longitudinal axis of the pin and cuts through the ring entirely. The centering of the pin by the slotted ring occurs in that the slanting bearing contours there are fashioned as conical surfaces. Thus, the conical surface of the slotted ring slides against the conical surface of the spring-loaded pin, and the ring is widened out until it rests against the inner wall of the mounting bracket.

Regardless of whether the elements of the holding device which are arranged movably to each other, namely the pin and the ring, perform their function perfectly during the operation of the holding device, which need not absolutely be the case on account of dirt and grime, the structural design of this holding device for the centering of the pin inside the mounting bracket is cumbersome and composed of several mutually moving parts, namely the pin and the ring.

Furthermore, there is known from DE 101 60 801 A1 a shifting mechanism with a movably mounted shift lever and a lock bolt arrangement interacting with the shift lever, having a lock bolt mounted to be axially movable in a lock bolt seat and pressed by a locking spring against a coordinated shifting gate. The lock bolt is provided with a plurality of lever-shaped movable pressing arms, distributed around its periphery, which are radially spread apart by a lock spring and bear under elastic pretensioning against the inner wall of the seat. The pressing arms here are each connected movably to the lock bolt via swivel points. KR 10 2014 003 45 50 A discloses a similar functional principle.

From DE 101 48 554 C1 there is known a shifting mechanism with a lock bolt mounted so as to be movable in the direction of its lengthwise dimension in a lock bolt housing and which is braced under spring tension in a shifting gate, having guiding means lying against the inner side of the lock bolt housing both in the region of its shaft, near its tip, and in the region of its rear end, reaching into the lock bolt housing. These guiding means are fashioned as bendable guide ribs, by which the lock bolt is guided in the lock bolt housing.

A similar configuration of a locking plunger for activating a driving direction display is known from DE 10 2009 058 719 A1.

EP 2 338 730 A1 discloses an arrangement for creating a feel for an operator element. The operator element has a plunger guided in a not otherwise described aperture, and axially slanting flexible ribs are present on the plunger.

EP 0 255 418 A1 likewise discloses a lock bolt guide.

Therefore, one problem which the invention proposes to solve is to modify a holding device of the aforementioned kind so that a reduction in the number of structural parts is achieved, while at the same time reducing the parts which are arranged movably to each other. Another problem of the invention is to provide a pin for arrangement in such a mounting bracket which can be arranged within such a holding device without a separate centering device and which can be securely centered during the operation of the holding device so that the proper functioning of the holding device is assured.

### SUMMARY OF THE INVENTION

The holding device according to one embodiment of the invention comprises a mounting bracket with a seat, a pin guided in the seat of the mounting bracket in lengthwise displaceable manner, spring-loaded, and having a pin head, and a centering device, while the pin head extends out from the seat of the mounting bracket. The holding device is characterized in that the centering device is arranged immovably on the pin and is provided with a restoring force inside the seat of the mounting bracket which is directed against the mounting bracket.

By means of the holding device according to one embodiment of the invention, it is now possible to arrange the pin with the centering device as a single piece inside the holding device during its manufacture, so that the expense during the assembly of the holding devices is minimized. Moreover, the centering device arranged immovably on the pin ensures that no complicated contours are needed for the centering device and the pin that slide against each other during the centering of the pin in the mounting bracket. Accordingly, the design cost for the manufacturing of the pin and the centering device and thus that for the entire holding device according to the invention is minimized, since no provision needs to be made for such geometries in the design and neither do they need to be obeyed in a tolerance range during the manufacturing. Furthermore, the number of mutually moving parts is minimized according to the invention, so that possible malfunctions caused by this are also minimized.

According to a first advantageous embodiment of the invention, the centering device and the pin consist of the same material. Thanks to this measure, it is easily possible to arrange the centering device and the pin immovably with respect to each other, for example by joining the two parts together, especially by welding.

However, it is of special benefit for the centering device and the pin to be fashioned as a single piece and to consist preferably of a plastic. A single-piece configuration of the centering device and the pin allow both parts to be manufactured together in a single manufacturing step. In this way, it is possible to do without connections of the centering device to the pin. This is especially advantageous, because such connections may represent weak points which can lead to faults during the operation of the holding device according to the invention and thus to malfunctions. It is especially advantageous for the centering device and the pin to be manufactured of plastic in an injection molding process.

According to another embodiment of the invention, the pin has a positioning element, which corresponds with a seat of the mounting bracket. This positioning element serves in particular for the pin always being mounted in the correct disposition in the mounting bracket. The correct disposition is in fact of immense importance here, because mutually corresponding elements are disposed in the pin and the mounting bracket, such as those of a Hall sensor, which enable an exact position determination of the pin and thus of the gearshift or the transmission of the motor vehicle comprising the holding device according to the invention.

In the holding device according to another embodiment of the invention, the centering device consists of at least one tab, but preferably of at least two tabs, which are disposed substantially equidistant around the periphery of the pin, on the pin itself. By means of such tabs, which are preferably fashioned as a single piece with the pin, it is now possible in easy manner to center the pin in the seat of the mounting bracket during the working of the holding device. Thanks to the arrangement of at least two tabs disposed equidistant over the periphery of the pin, preferably being identical in configuration, an especially easy precise centering of the pin in the seat of the mounting bracket is afforded. It has proven to be especially advantageous to use four identical tabs, which are arranged at 90 degree spacing around the periphery of the pin, preferably—but not necessarily—at the same height. The use of four such tabs is an especially good compromise in terms of an ideal number of tabs, in order to accomplish an exact centering of the pin in the seat of the mounting bracket, whereas these nave the necessary stiffness and elasticity for the constant centering, especially when they are made of a plastic.

According to yet another embodiment of the invention, furthermore, it is provided that the at least one tab when the pin is disposed inside the seat of the mounting bracket contacts by a contact surface an inner wall of the mounting bracket, wherein preferably the contact surface runs parallel to the inner wall. In this way, it is possible to center the pin in easy manner in the seat of the mounting bracket, forming an equidistant gap between the pin and the mounting bracket except in the region of the tabs. Thanks to the formation of this equidistant gap, an exact centering of the pin in the seat of the mounting bracket is even further improved.

According to an especially advantageous embodiment of the invention, the at least one tab has a spring element, which when the pin is disposed inside the seat of the mounting bracket is held spring-loaded in a cavity arranged on the pin. The tabs are arranged on the pin such that their restoring force is oriented in the normal direction to the longitudinal axis of the pin. Thanks to such a configuration of the invention, it is possible to mount the pin with spring-loading in the seat of the mounting bracket during the working of the holding device, so that forces acting on the holding device can also be cushioned without the holding device leaving its predetermined position as a result of the action of the forces. Furthermore, this ensures that the pin is exactly and securely centered over its entire lengthwise dimension in the seat of the mounting bracket, without any tilting movements of the pin occurring, which might move the pin at least partly out from the exact centered position.

According to another embodiment of the invention, the at least one tab is held in a tab seat of the mounting bracket. In this case, contrary to the previously described embodiment of the tabs, the restoring force of the tabs acts not in the normal direction to the longitudinal axis of the pin, but instead in a tangential direction. Thanks to such an embodiment of the invention, furthermore, a twisting of the pin in the seat of the mounting bracket is avoided. The avoidance of such a twisting is absolutely necessary, since the correct disposition of the pin inside the mounting bracket is in fact of enormous importance, because mutually corresponding elements are disposed in the pin and the mounting bracket, such as those of a Hall sensor, which enable an exact position determination of the pin and thus of the gearshift or the transmission of the motor vehicle comprising the holding device according to the invention.

It has proven to be advisable for the at least one tab to consist of an L-shaped element and an I-shaped element, which are arranged on the pin spring-loaded against each other. Thanks to this embodiment of the invention, it is easily possible to place the tabs of the pin spring-loaded in the tabs of the mounting bracket. The L-shaped elements are spaced apart from the respective I-shaped elements at all times, so that a spring-loading of the tabs in the tab seat and thus an exact centering of the pin in the mounting bracket is always assured.

Advantageously, the mounting bracket is cross-shaped, so that four tabs are present, with which a corresponding tab of a pin having four tabs can engage each time, likewise being arranged on it in cross shape and displaced by 90 degrees each time.

According to another embodiment of the invention, a compression spring is provided for the spring-loading of the pin, being preferably braced by its first end against an end stop of the mounting bracket and by its second end against an end stop of the pin, meaning by an end stop on the pin also that this end stop is optionally situated at the at least one tab of the pin. Thanks to such a compression spring, it is ensured that the pin is held securely in the pin head seat by its pin head during the working of the holding device and continuously contacts its contact surface.

Moreover, the holding device is designed for arrangement on a shift lever of a shifting device of a transmission of a motor vehicle, optionally with a shift rod or shift train placed in between, while the pin head is designed to bear against a contact surface of a pin head seat.

The pin according to one embodiment of the invention for arrangement in an above-described holding device comprises a pin head and a pin body and is characterized in that at least one tab is provided, which is fastened on the pin and which can swivel to produce a restoring force against the pin. In one advantageous embodiment of the invention, the pin is manufactured as a single piece with the at least one tab, preferably of a plastic.

The at least one tab comprises a spring element, which when the at least one tab is swiveled can be received with spring loading in a cavity arranged on the pin.

Furthermore, the pin has an end stop, against which a compression spring arranged between pin and mounting bracket of an above-described holding device can be braced.

According to another embodiment of the invention, the at least one tab of the pin is designed to be mounted in a tab seat of a mounting bracket of an above described holding device.

Further aims, advantages, features and application possibilities of the present invention will emerge from the following description of a sample embodiment by means of the drawings. All features described and/or illustrated graphically form subject matter of the present invention in themselves or in any logical combination, even independently of their summarization in or referral back to the claims.

### DESCRIPTION OF THE DRAWINGS

There are shown:

FIG. 1: a sample embodiment of a shifting device for the activating of gearboxes in motor vehicles with a sample embodiment of a holding device according to the invention,

FIG. 2: a sample embodiment of a holding device according to the invention in a side view,

FIG. 3: the holding device of FIG. 2 in a top view from the front,

FIG. 4: a sample embodiment of a pin according to the invention,

FIG. 5: a cross sectional representation of a holding device according to the invention,

FIG. 6: another sample embodiment of a shifting device for the activating of gearboxes in motor vehicles with another sample embodiment of a holding device according to the invention,

FIG. 7: the holding device of FIG. 6 in a view from below,

FIG. 8: the shifting device of FIG. 6 in a perspective view,

FIG. 9: the holding device of FIG. 7 in a view from below without a pin inserted into the mounting bracket,

FIG. 10: the holding device of FIG. 9 with a pin arranged in the mounting bracket,

FIG. 11: a pin according to the invention for a holding device of FIGS. 6 to 10 in a perspective representation,

FIG. 12: the pin of FIG. 11 in a view from below in a disassembled state, and

FIG. 13: the pin of FIG. 11 in a view from below in an assembled state.

### DETAILED DESCRIPTION

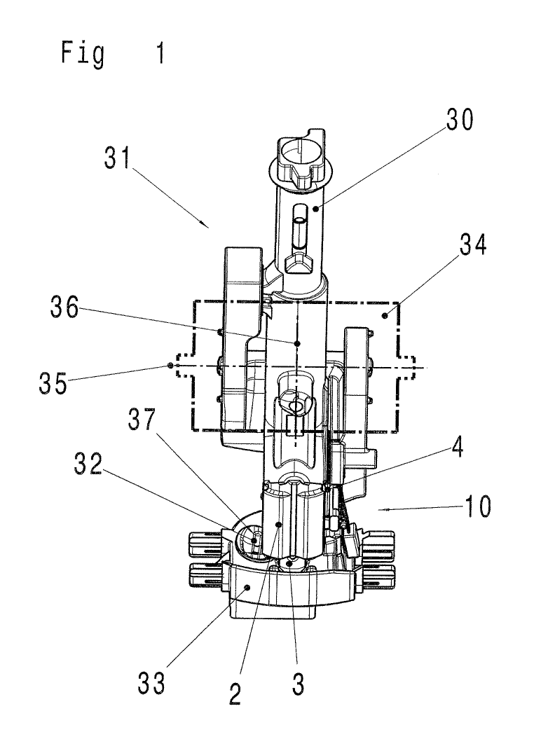

FIG. 1 shows for example the construction of a shifting device 31 for the activating of a gearbox of a motor vehicle, yet without showing the gearshift housing which is firmly connected to the vehicle structure. In the gearshift housing which is firmly connected to the vehicle structure there is swivel-mounted a shift lever 30 by means of a pivot 34 about a first swivel axis 35 and a second swivel axis 36.

At the lower part of the shift lever 30, located beneath the pivot in the gearshift housing, there is provided a holding device 10 firmly connected to the shift lever 30, consisting of a mounting bracket 2 having a seat 1 and a pin 4 which is displaceably movable in the seat 1 of the mounting bracket 2, while a pin head 3 is arranged at the end of the pin 4 sticking out from the seat 1 of the mounting bracket 2. The holding device 10 with its mounting bracket 2 and its pin 4 form a locking device, together with a pin head seat 33 which is firmly connected to the gearshift housing. The pin head seat 33 comprises a guide groove 37 and a contact surface 32, which stands in contact with the pin 4 or the pin head 3.

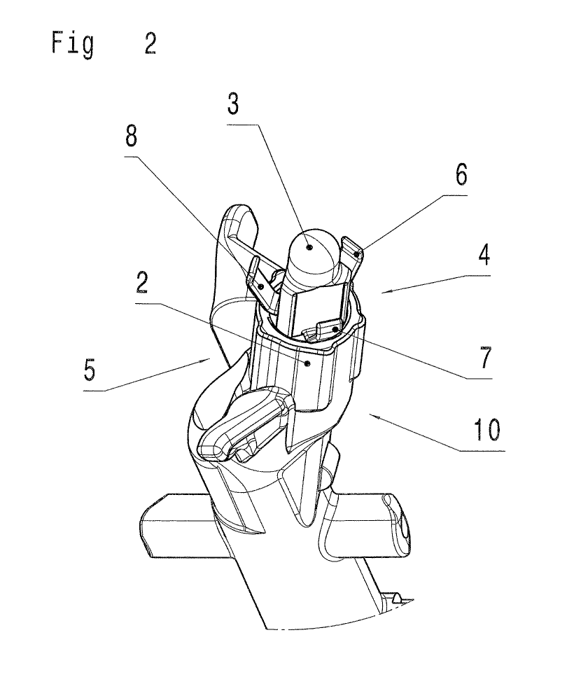

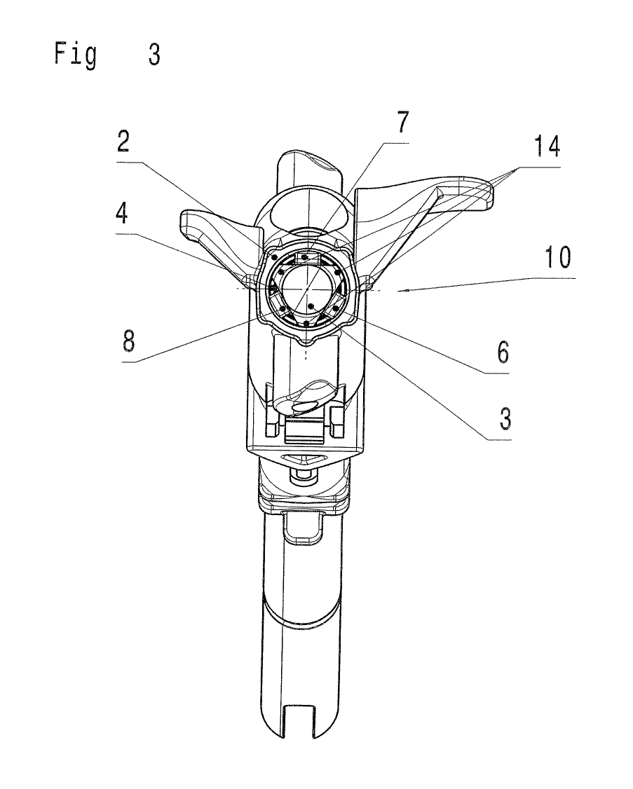

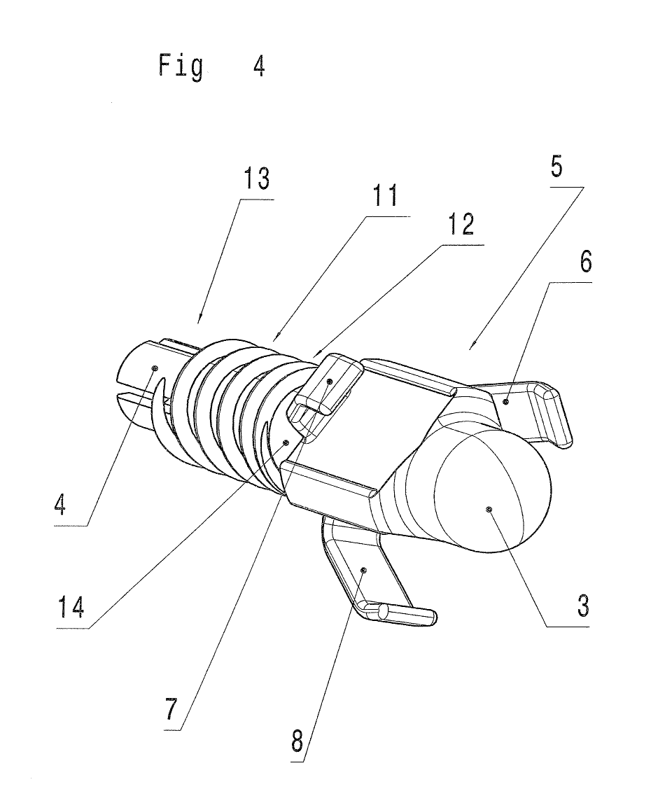

A first possible sample embodiment of a holding device 10 according to the invention is shown in various representations in FIGS. 2 and 3. The pin 4 or the pin head 3 is designed so that it stands in contact with the contact surface 32 of the pin head seat 33 when the holding device is installed in a shifting device according to FIG. 1. The pin 4 or its pin head 3 correspond to the contact surface 32 of the pin head seat 33 such that the pin head 3 can lock into a corresponding seat of the pin head seat 33. This locked position of the pin head 3 is shown as an example in FIG. 1.

This pin 4 is arranged displaceably along its lengthwise axis 9 in the seat 1 of the mounting bracket 2. In the sample embodiments of the holding device 10 or the pin 4 represented in the figures, the pin 4 comprises three tabs 6, 7 and 8, which are evenly arranged at a 120° offset over the periphery of the pin 4 at the same height and which serve as a centering device 5 for the pin 4. The pin 4 and the tabs 6, 7 and 8 are made as a single piece from a plastic.

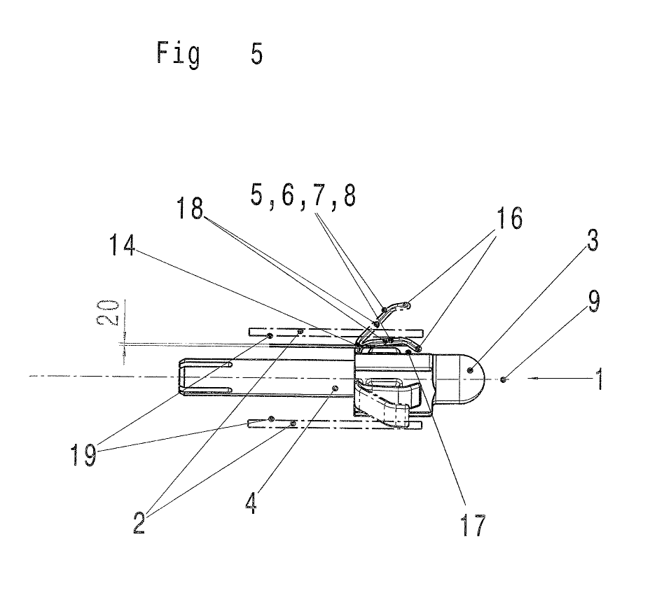

The tabs 6, 7 and 8 designed as a centering device 5 are molded on the pin 4 so that they stand out from the pin 4 at an angle in the state outside of the seat 1 of the mounting bracket 2, as is shown for example in the partial representation of FIG. 5. Once the pin is introduced into the seat 1 of the mounting bracket 2, however, the tabs 6, 7 and 8 swivel to produce a restoring force in the direction of the pin 4.

If the pin 4 with the tabs 6, 7 and 8 is not received functionally in the seat 1 of the mounting bracket 2, as is shown in the other partial representation of FIG. 5, the tabs 6, 7 and 8 lie with contact surfaces 18 against the inner wall 19 of the mounting bracket 2. In this position, spring elements 16 of the tabs 6, 7 and 8 are received in corresponding cavities 17 of the pin 4.

Thanks to the restoring force of the tabs 6, 7 and 8, the pin is securely and exactly centered inside the seat 1 of the mounting bracket 2, forming an equidistant gap 20 between pin 4 and inner wall 19 of the mounting bracket 2. The spring elements 16 serve for the pin 4 to remain securely in the centered position inside the seat 1 of the mounting bracket 2 even when external forces are acting.

Because the contact surfaces 18 of the tabs 6, 7 and 8 stand in contact with the inner wall 19 of the mounting bracket 7 for their entire lengthwise extension, it is furthermore ensured that the pin 4 is exactly centered for its entire lengthwise extension inside the seat 1 of the mounting bracket 7 and no tilting movement perpendicular to the lengthwise extension of the pin 4 can occur, which might move the pin 4 at least partly from its centered position inside the seat 1 of the mounting bracket 2.

So that the pin 4 or the pin head 3 is always in contact with the contact surface 32 of the pin head seat 33 during the functional use of the holding device 10, the pin 4 is spring-loaded inside the seat 1 of the mounting bracket 2 by means of a compression spring 11. The compression spring 11 is braced by its first end 12 against an end stop 14 of the pin 4 and by its second end 13 against an end stop 15 of the mounting bracket 2.

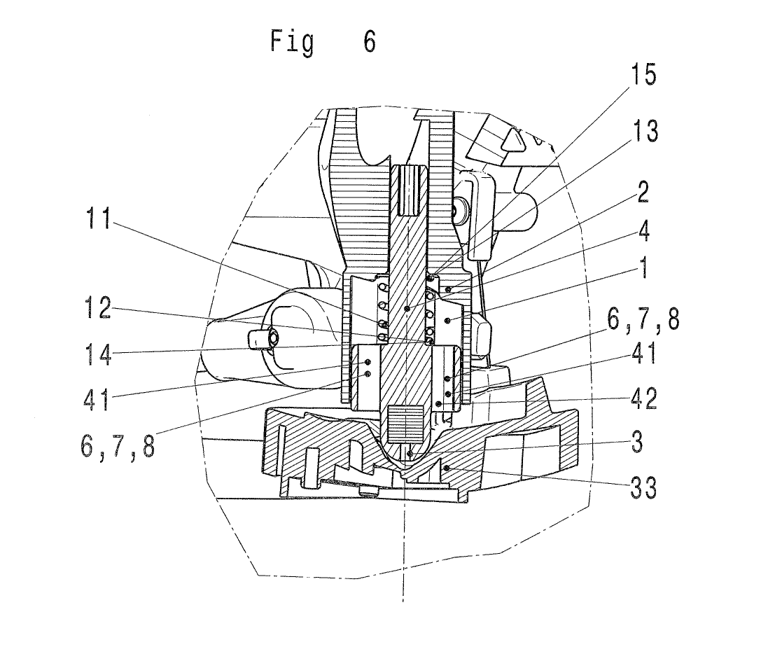

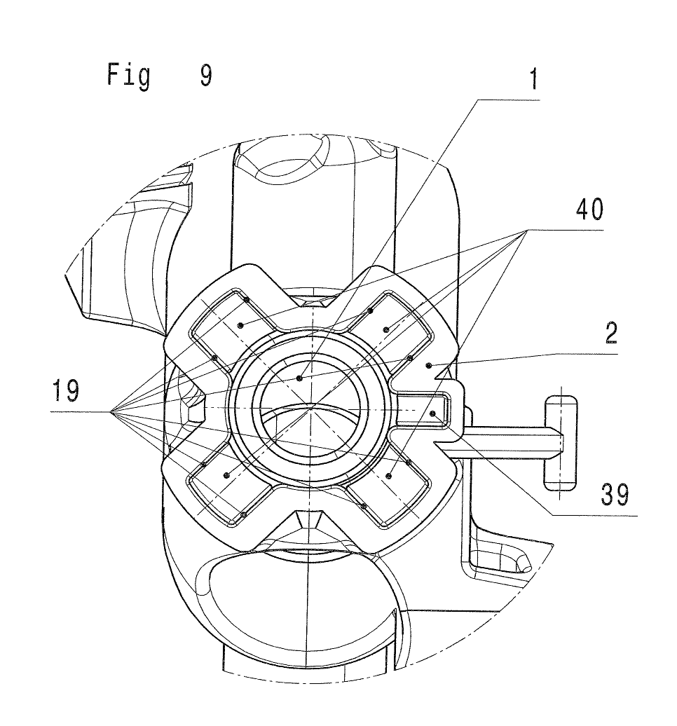

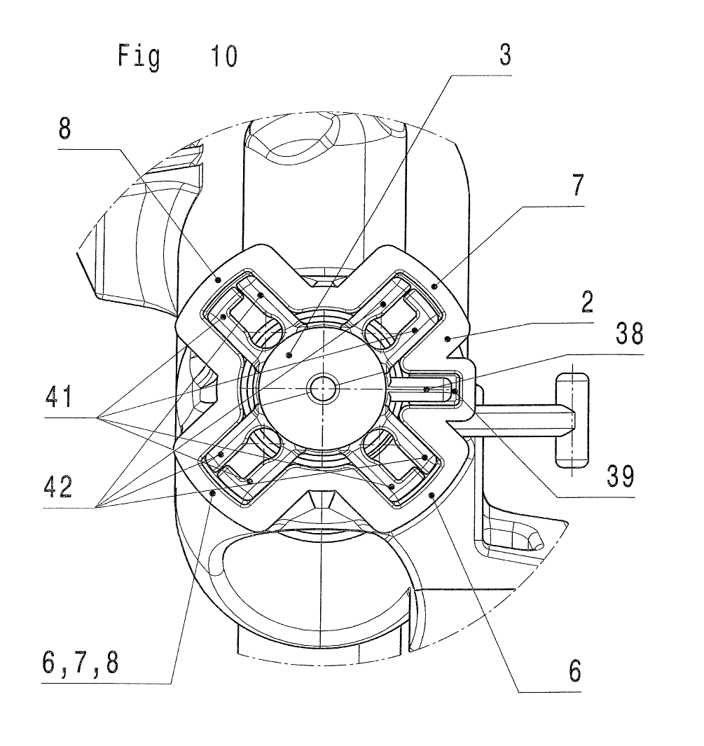

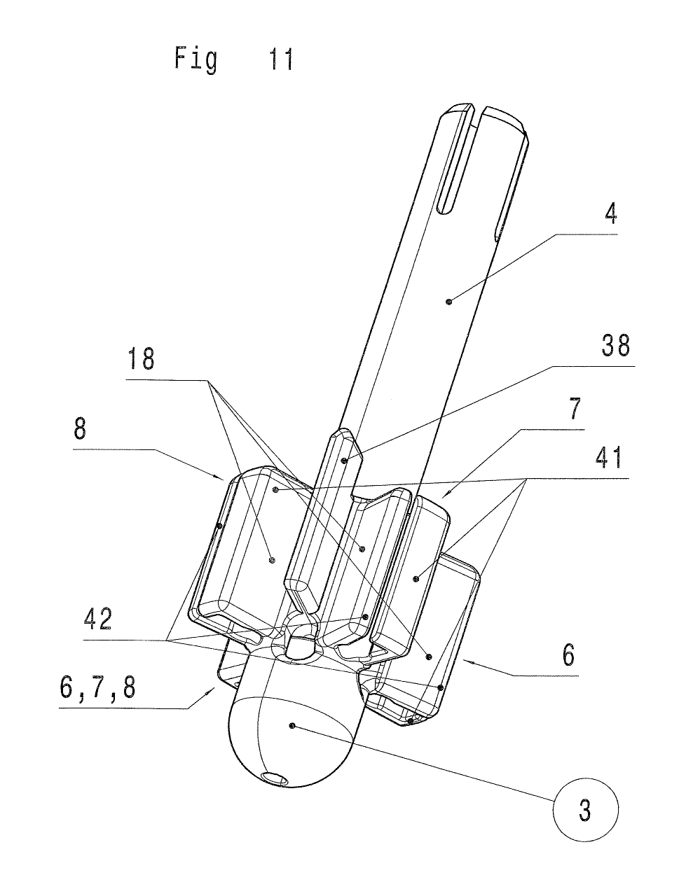

FIGS. 6 to 13 show another sample embodiment of a holding device according to the invention or a pin for this sample embodiment of a holding device according to the invention.

In this sample embodiment as well, the pin 4 is spring-loaded inside the seat 1 of the mounting bracket 2 by means of a compression spring 11, so that the functional use of the holding device is assured, as already described above for the first sample embodiment. The compression spring 11 is again braced here by its first end 12 against an end stop 14 of the pin 4 and by its second end 13 against an end stop 15 of the mounting bracket 2.

The seat 1 of the mounting bracket 2 of this sample embodiments is shaped as a cross. Thanks to this cross shape of the seat 1 of the mounting bracket 2, tab mounts 40 are formed in the seat 1, in which tabs 6, 7, 8 of the pin 4 can be received. The tabs 6, 7, 8 of the pin 4 are likewise arranged in a cross shape, each offset by 90° about the periphery of the pin 4, on the pin itself.

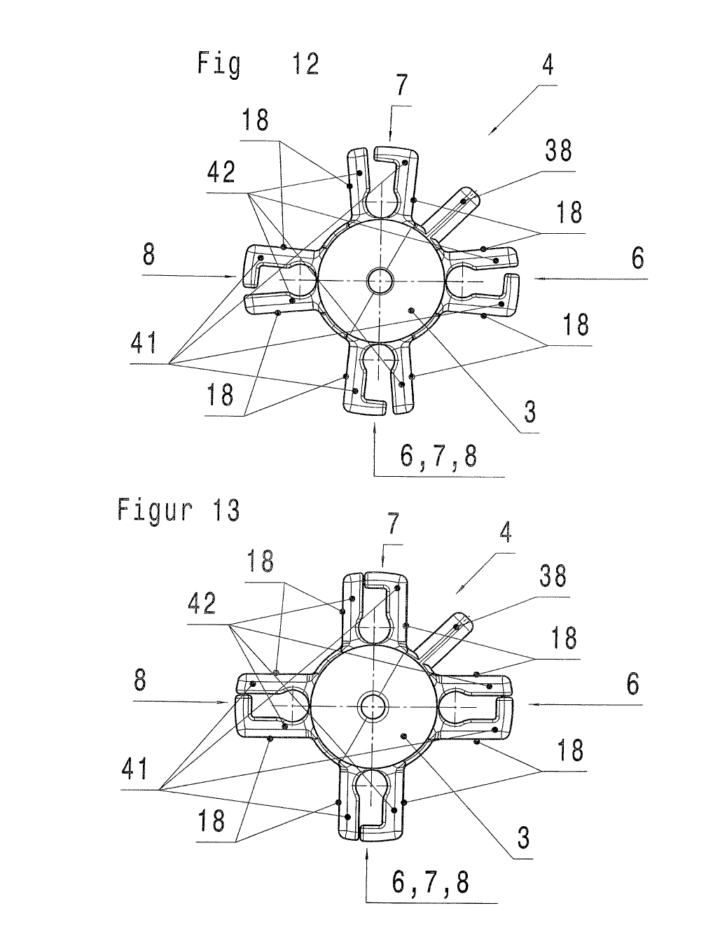

The tabs 6, 7, 8 in this sample embodiment are formed by an L-shaped element 41 and an I-shaped element 42, each of them arranged on the pin 4, while both the L-shaped element 41 can swivel spring-loaded against the I-shaped element 42 and vice versa the I-shaped element 42 can swivel spring-loaded against the L-shaped element 41, producing a restoring force. The L-shaped element 41 and the I-shaped element 42 are arranged spring-loaded against each other on the pin 4 such that in both the installed state, as shown in FIG. 13, and in the non-installed state, as shown in FIG. 12, they are always spaced apart from each other, so that at all times the spring property of the respective tabs 6, 7, 8 is assured in both the installed and the non-installed state.

Both the L-shaped element 41 and the I-shaped element 42 have contact surfaces 18, which in the installed state come to lie against an inner wall 19 of the mounting bracket 2. Thanks to the spring-loading of the tabs 6, 7, 8 or the I-shaped elements 42 and L-shaped elements 41, an exact centering of the pin 4 inside the seat 1 of the mounting bracket 2 is always assured in the installed state of the pin 4 in the seat 1 of the mounting bracket 2.

Moreover, in this sample embodiment the pin 4 according to the invention comprises a positioning element 38, which in the mounted state of the pin 2 can be received in a corresponding seat 39 of the mounting bracket 2 of the holding device 10. This positioning element 38 serves substantially for the pin 4 to be installed in its correct position in the mounting bracket 2. This is of immense importance, because the pin 4 and the mounting bracket 2 generally comprise mutually corresponding elements, not shown here, such as those of a Hall sensor, which enable an exact position determination of the pin 4 and thus of the gearshift or the transmission of the motor vehicle comprising the holding device 10 according to the invention.

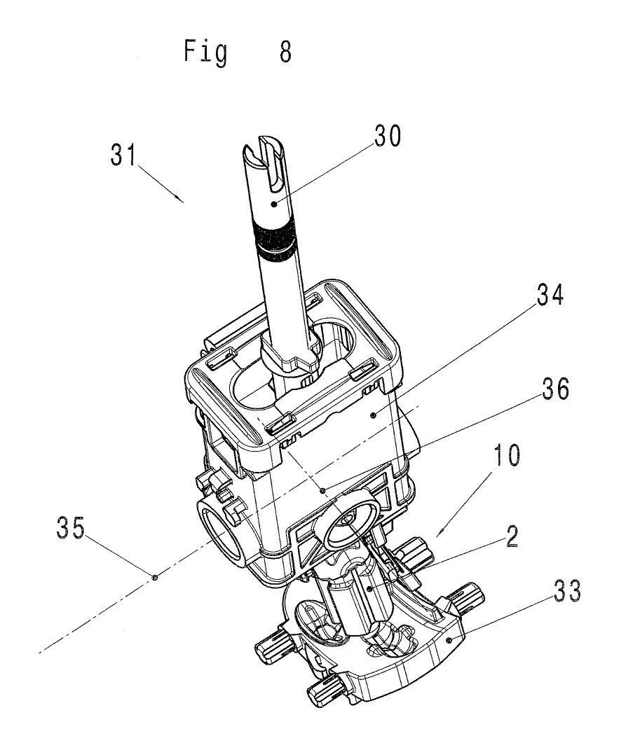

As shown especially in FIG. 8, the holding device 10 according to the invention is integrated in a shifting device 31. The shifting device 31 comprises a shift lever 30, which is mounted by means of a pivot 34 to swivel about a first swivel axis 35 and about a second swivel axis 36.

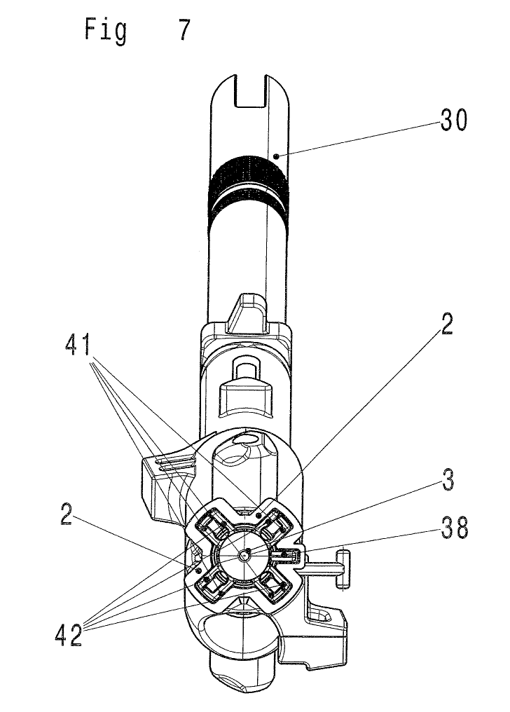

The overall holding device 10 in this sample embodiment is angled with respect to the shift lever 30, as is shown especially clearly by FIG. 8 and also the representation of FIG. 7.

### LIST OF REFERENCE NUMERALS

1 seat
2 mounting bracket
3 pin head
4 pin
5 centering device
6 tab
7 tab
8 tab
9 lengthwise axis
10 holding device
11 compression spring
12 first end
13 second end
14 end stop
15 end stop
16 spring elements
17 cavity
18 contact surface
19 inner wall
20 gap
30 shift lever
31 shifting device
32 contact surface
33 pin head seat
34 pivot
35 first swivel axis
36 second swivel axis
37 guide groove
38 positioning element
39 seat
40 tab mounts
41 L-shaped element
42 I-shaped element

1. A holding device (10), comprising:
a) a mounting bracket (2) with a seat (1),
b) a pin (4) guided in the seat (1) of the mounting bracket (2) in lengthwise displaceable manner, spring-loaded, and having a pin head (3), the pin head (3) extending out from the seat (1) of the mounting bracket (2), and
c) a centering device (5), wherein
the centering device (5) is arranged immovably on the pin (4) and is provided with a restoring force inside the seat (1) of the mounting bracket (2) which is directed against the mounting bracket (2), and the centering device (5) comprises at least one tab (6, 7, 8), which is disposed substantially equidistant around the periphery of the pin (4), on the pin itself, and the at least one tab (6, 7, 8) when the pin (4) is disposed inside the seat (1) of the mounting bracket (2) contacts by a contact surface (18) of an inner wall (19) of the mounting bracket (2), and wherein the contact surface (18) runs parallel to the inner wall (19), and the tab (6, 7, 8) is swivelable to produce a restoring force against the pin (4).

2. The holding device according to claim 1, wherein the centering device (5) and the pin (4) are formed of the same material.

3. The holding device according to claim 1, wherein the centering device (5) and the pin (4) are fashioned as a single piece and consist of a plastic.

4. The holding device according to claim 1, wherein the pin (4) has a positioning element (38), which corresponds with a seat (39) of the mounting bracket (2).

5. The holding device according to claim 1, wherein the at least one tab (6, 7, 8) has a spring element (16), which when the pin (4) is disposed inside the seat (1) of the mounting bracket (2) is held spring-loaded in a cavity (17) arranged on the pin (4).

6. The holding device according to claim 1, wherein the at least one tab (6, 7, 8) is held in a tab seat (40) of the mounting bracket (2).

7. The holding device according to claim 6, wherein the at least one tab (6, 7, 8) consists of an L-shaped element (41) and an I-shaped element (42), which are arranged on the pin (4) spring-loaded against each other.

8. The holding device according to claim 1, wherein a compression spring (11) is provided for the spring-loading of the pin (2), with said compression spring (11) braced by its first end (12) against an end stop (14) of the mounting bracket (2) and by its second end (13) against an end stop (15) of the pin (4).

9. The holding device according to claim 1, wherein said holding device is adapted for arrangement on a shift lever (30) of a shifting device (31) of a transmission of a motor vehicle, with the pin head (3) bearing against a contact surface (32) of a pin head seat (33).

10. A pin (4) for arrangement in a holding device (10) according to claim 1, comprising: a pin head (3), wherein the at least one tab (6, 7, 8) is fastened on the pin (4) and is swivelable to produce a restoring force against the pin (4).

11. The pin (4) according to claim 10, wherein the at least one tab (6, 7, 8) comprises a spring element (16), which when the at least one tab (6, 7, 8) is swiveled is adapted to be received with spring loading in a cavity (17) arranged on the pin (4).

12. The pin (4) according to claim 12, wherein the holding device has a tab seat (40) and the at least one tab (6, 7, 8) is adapted to be mounted in the tab seat (40) of the holding device.
